(19) United States
(12) Patent Application Publication
(10) Pub. No.: US 2013/0007965 A1
(43) Pub. Date: Jan. 10, 2013

(54) GOLFING DISTANCE MEASURING DEVICE

(76) Inventor: Robert Leap, Charleston, SC (US)

(21) Appl. No.: 13/179,467

(22) Filed: Jul. 8, 2011

(51) Int. Cl. A63B 57/00; G01B 3/00

(52) U.S. Cl. 7/164

(57) ABSTRACT

The present invention is a golfing distance measuring device utilized by a user to measure a distance between a golf hole and one or more golf balls. The device includes an aluminum base paddle with a rectangular portion and a handle portion with a pointed end, a hook that is releasably attached to a flagstick that is placed in the hole and a measuring tape disposed on the rectangular portion with the hook disposed on the end. The device also includes one or more pieces of writing paper and pencils that allows a user to record notes, scores, distances, names and other golf-related information and data, a pair of writing paper clips to secure the writing paper to the rectangular portion and one or more pencil dips to secure the pencils to the rectangular portion.

### TECHNICAL FIELD & BACKGROUND

During many golf tournaments, blitzes and skin games, contests are held on par 3 holes for the person that hits their golf ball closest to the hole. Therefore, it becomes necessary to obtain a quick and accurate measurement so as to not hold-up play. To obtain an accurate distance, the measurement must be taken from the flag stick while it is still in the hole. This is necessary because the ball being round, can hang over the cup without being in the hole. Current methods and devices for obtaining these measurements are not very accurate or require two persons and do not have a place to record the names and distances of the participants.

The present invention generally relates to a distance measuring device. More specifically, the invention is a golfing distance measuring device.

It is an object of the invention to provide a golfing distance measuring device for measuring distances between one or more golf balls and a hole on a putting green.

It is an object of the invention to provide a golfing distance measuring device that allows a user to relatively easily write notes, scores and other relatively important information and data.

What is really needed is a golfing distance measuring device for measuring distances between one or more golf balls and a hole on a putting green that allows a user to relatively easily write notes, scores and other relatively important information and data.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a distance measuring device, in accordance with one embodiment of the present invention.

FIG. 1B illustrates a rear perspective view of a distance measuring device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

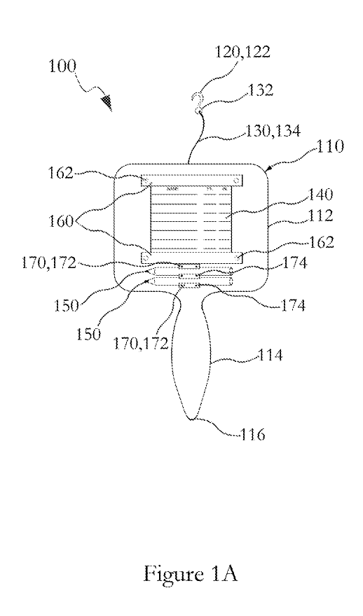

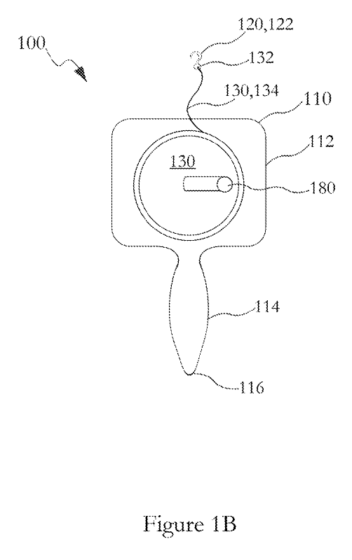

FIG. 1A illustrates a front perspective view of a distance measuring device 100, in accordance with one embodiment of the present invention. The distance measuring device 100 includes a base paddle 110, a hook 120, a measuring tape 130, one or more pieces of writing paper 140, one or more pencils 150, a pair of writing paper clips 160 and one or more pencil clips 170. Specifically, the distance measuring device 100 is utilized to measure the distance between a golf ball and a hole on a putting green (all not shown).

The base paddle 110 has a rectangular portion 112 and a handle portion 114 and is made of aluminum or other suitable material. The handle portion 114 has a pointed end 116 and can be utilized as a ground insert or stake to insert into a ground surface outside of a putting surface to removably secure the distance measuring device 100. The hook 120 is releasably attached to a flagstick that is placed in a hole on a putting green. The hook 120 can be an S hook 122 or other suitable type of hook. The measuring tape 130 has a distal end 132 and a plurality of measuring indicia 134 and measures the distance between a golf ball and a hole on a putting green. The distance measurement is based on the measuring indicia 134 disposed on the measuring tape 130. The measuring tape 130 utilized is 50 feet in length, but can be other suitable lengths. The hook 120 is disposed on the distal end 132 of the measuring tape 130.

The writing paper 140 is provided for a user to record notes, scores distances, names and other relatively important golf-related information and data. The pencils 150 are provided to allow a user to write notes, scores, distances, names and other relatively important golf-related information and data on the writing paper 140. The writing paper clips 160 secure the writing paper 140 to the rectangular portion 112. The writing paper clips 160 are attached to the rectangular portion 112 of the base paddle 110 with a plurality of pop rivets 162 or other suitable fasteners. The pencil clips 170 secure the pencils 150 to the rectangular portion 112 with a snap clip 172, although other suitable clips may also be utilized. The pencil clips 170 are attached to the rectangular portion 112 of the base paddle 110 with a plurality of sheet metal screws 174 or other suitable fasteners.

FIG. 1B illustrates a rear perspective view of a distance measuring device 100, in accordance with one embodiment of the present invention. The distance measuring device 100 includes the previously described base paddle 110 with a rectangular portion 112 and a handle portion 114, the hook 120, the measuring tape 130 and a tape measure handle 180. The tape measure handle 180 is rotated to reel-in the measuring tape 130 when extended. All other features of the distance measuring device 100 are identical as previously described in FIG. 1A and its description.

The golfing distance measuring device includes an aluminum paddle with a pointed handle end which is equipped with a fifty foot tape measure with a hook attachment. When using the golfing distance measuring device, a user simply fastens the hook around the flag stick, while holding the handle and extends the tape measure to the golf ball which provides a precise measurement of the distance between the two elements. If two or more balls appear to be similar distances, a user simply walks around the green to the next golf ball with the hook still attached to the flag stick to determine which golf ball is closer to the hole. When completed, the hook is removed from the flagstick, the tape is rewound and the name and distance is recorded on the provided writing paper. The golfing distance measuring device also conveniently includes a pencil holder and two clips for attaching writing paper, permitting the user to easily update pertinent information at all times. The versatile and easy to use golfing distance measuring device will be readily available in various colors at retail sporting goods stores.

The golfing distance measuring device is the only product of its kind that features a 6 inch wide, 12 inch high, and ⅛″ inch thick aluminum paddle equipped with a pointed handle end to hold while extending and retrieving the tape and for inserting the device into the ground off of the putting green. The golfing distance measuring device is designed to be self contained, easily operated, relatively more durable, lighter and more accurate than traditional methods for measuring and recording names and distances during par 3 and other golfing contests.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A golfing distance measuring device utilized by a user to measure a distance between a golf hole and one or more golf balls, comprising:
a base paddle with a rectangular portion and a handle portion;
a hook that is releasably attached to a flagstick that is placed in said hole;
a measuring tape disposed on said rectangular portion with a distal end, a plurality of measuring indicia and a handle that measure a distance between said one or more golf balls and said hole with said hook disposed on said distal end;
one or more pieces of writing paper that allows a user to record notes, scores, distances, names and other golf-related information and data;
one or more pencils to write said notes, scores, distances, names and other golf-related information and data;
a pair of writing paper clips secured to said rectangular portion to secure said writing paper to said rectangular portion; and
one or more pencil clips secured to said rectangular portion to secure said pencils to said rectangular portion.

2. The device according to claim 1, wherein said handle portion has a pointed end.

3. The device according to claim 2, wherein said handle portion is utilized as a ground insert outside of a putting surface.

4. The device according to claim 1, wherein said hook is an S hook.

5. The device according to claim 1, wherein said user measures a first distance and walks over and compares said first distance to a second distance with said measuring tape.

6. The device according to claim 1, wherein said measuring tape is approximately 50 feet in length.

7. A golfing distance measuring device utilized by a user to measure a distance between a golf hole and one or more golf balls, comprising:
an aluminum base paddle with a rectangular portion and a handle portion;
a hook that is releasably attached to a flagstick that is placed in said hole;
a measuring tape disposed on said rectangular portion with a distal end, a plurality of measuring indicia and a handle that measure a distance between said one or more golf balls and said hole with said hook disposed on said distal end;
one or more pieces of writing paper that allows a user to record notes, scores, distances, names and other golf-related information and data;
one or more pencils to write said notes, scores, distances, names and other golf-related information and data;
a pair of writing paper clips secured to said rectangular portion to secure said writing paper to said rectangular portion; and
one or more pencil cups secured to said rectangular portion to secure said pencils to said rectangular portion.

8. The device according to claim 7, wherein said base paddle is approximately 6 inches wide, 12 inches high and ⅛ thick.

9. The device according to claim 7, wherein said handle portion has a pointed end.

10. The device according to claim 9, wherein said handle portion is utilized as a ground insert outside of a putting surface.

11. The device according to claim 7, wherein said hook is an S hook.

12. The device according to claim 7, wherein said user measures a first distance and walks over and compares said first distance to a second distance with said measuring tape.

13. The device according to claim 7, wherein said measuring tape is approximately 50 feet in length.

14. A golfing distance measuring device utilized by a user to measure a distance between a golf hole and one or more golf balls, comprising:
an aluminum base paddle with a rectangular portion and a handle portion with a pointed end;
a hook that is releasably attached to a flagstick that is placed in said hole;
a measuring tape disposed on said rectangular portion with a distal end, a plurality of measuring indicia and a handle that measure a distance between said one or more golf balls and said hole with said hook disposed on said distal end;
one or more pieces of writing paper that allows a user to record notes, scores, distances, names and other golf-related information and data;
one or more pencils to write said notes, scores, distances, names and other golf-related information and data;
a pair of writing paper clips secured to said rectangular portion with a plurality of rivets to secure said writing paper to said rectangular portion; and
one or more pencil clips secured to said rectangular portion with a plurality of screws to secure said pencils to said rectangular portion.

15. The device according to claim 14, wherein said base paddle is approximately 6 inches wide, 12 inches high and ⅛ thick.

16. The device according to claim 14, wherein said handle portion has a pointed end.

17. The device according to claim 16, wherein said handle portion is utilized as a ground insert outside of a putting surface.

18. The device according to claim 14, wherein said hook is an S hook.

19. The device according to claim 14, wherein said user measures a first distance and walks over and compares said first distance to a second distance with said measuring tape.

20. The device according to claim 14, wherein said measuring tape is approximately 50 feet in length.
